(19) United States
(12) Patent Application Publication
(10) Pub. No.: US 2004/0167852 A1
(43) Pub. Date: Aug. 26, 2004

(54) Payment system

(76) Inventors: Nicholas Leeds Cutler, New South Wales (AU); Andrew Michael McPhail, New South Wales (AU); Andrew Kazamias, New South Wales (AU)

Correspondence Address: Fay Kaplun & Marcin, Suite 702, 150 Broadway, New York, NY, 10038, US

(21) Appl. No.: 10/477,825

(22) PCT Filed: May 8, 2002
(86) PCT No.: PCT/AU02/00568

(30) Foreign Application Priority Data
May 9, 2001 (AU) PR4863

(51) Int. Cl. G06F 17/60

(52) U.S. Cl. 705/39

(57) ABSTRACT

A payment and distribution system (1) allows a retailer (2) to be supplied with one or more goods (3) that have been ordered from a wholesaler (4). System (1) includes a remote delivery terminal (5) that is associated with a delivery vehicle (6) of a delivery agent. Vehicle (6) provides for the transport of goods (3) to the first party. Terminal (5) is responsive to the retailer (2) for providing a confirmation signal to confirm that goods (3) have been transported to the retailer and to provide a predetermined value for the goods. A provider server (7) is operated by a provider (8) for receiving the confirmation signal and for maintaining a first account for retailer (2) and a second account for wholesaler (4), wherein, in response to the confirmation signal, the first account is debited by the and second account is credited.

### FIELD OF THE INVENTION

The invention relates to a payment system and in particular to a payment system for allowing a first party to be supplied with one or more goods from a second party.

The invention has been developed primarily for facilitating the supply of consumables such as foodstuffs over a widely distributed network of retail outlets and will be described hereinafter with reference to that application. However, the invention is not limited to that particular field of use and is also suitable for the distribution of other items and services and for use with more localised networks.

### DISCUSSION OF THE PRIOR ART

The history of transaction systems such as electronic payment systems—or what is commonly referred to as Electronic Fund Transfer (EFT)—is one that has been dominated by only a select number of players over the past 20 years, namely the banks, other financial institutions, and a few credit card organisations. These banks have effectively created transaction networks which they almost solely operate and control by reliance upon legislative monopoly positions and alliances. For example, in the 1950's and 1960's certain banks co-operated with other financial institutions via joint owned cheque clearing houses and more recently through the ownership and control of electronic switching houses, which are otherwise known as interchanges or automated clearing houses (ACH).

Conceptually, the known EFT system operates as schematically shown in FIG. 2 and the wholesale route trade that has developed to accommodate the present system is shown in FIG. 4.

Even with the advent of the credit card revolution in the 1970's and the subsequent rise in electronic payment networks and EFT, the banks successfully maintained control and exclusivity of participation in these newly and rapidly expanding networks of the time. With the formation and eventual control of both Visa and Mastercard brands the banks immediately established their dominance in the credit card market and, therefore, guaranteed their continued control of the bulk of the worldwide ‘retail’ payment systems. In the 1980's, as credit card usage grew so too did the roll out rate of the bank's and credit card's electronic networks resulting in the electronic linking of the majority of merchants worldwide. Although most banks pursued construction of their own private networks, standardisation eventually began to occur and by the 1990's most banks networks where, if not completely interoperable with one another, were enabled to facilitate transactions between users from different bank owned networks. In Australia the bank owned electronic networks of this kind are referred to as EFTPOS & ATM networks. As presently implemented, these networks enable both credit and debit card transactions for all of the bank debit and credit products that are accessible via cards.

However, since the proliferation and commercialisation of the Internet and other wireless mobile communication networks in the 1990's, the banks and credit card institutions have been faced with the challenge of adapting their existing closed network architecture to suit the new demands of the open e-commerce environment.

The primary challenge presented to all the financial institutions is due to the open nature of the Internet and the raft of security issues that subsequently arise. Products like credit and debit cards and their subsequent standards and protocols were designed primarily for use in a closed or private electronic network and therefore use of such products on the Internet, although possible, enormously increases the risk of fraud by third parties at non-bank locations. Alternatively, if adequate system security protocols were employed they would reduce the products functionality and in a worst case scenario may make the transaction so slow as to be inoperable or at the very least impractical. Moreover, the cost of the transaction would be prohibitive because of the infrastructure and switching-costs.

Indeed, security is considered the most critical issue facing the overall success of Electronic Commerce.

Due to the banks and credit card companies' vast investment into their landline based network architecture over the past 20 years there is considerable inertia and perhaps even a reticence to build new types of electronic networks. To gain the best return from the existing infrastructure, the approach of the established players has been to concentrated on creating new e-commerce products and services that can still be inter-operable with or delivered on their landline based closed networks. Therefore, although products and services such as phone and net banking have proliferated in the 1990's, almost all of the financial institutions' other recent product and service offerings are neither designed nor optimised for use with the latest technologies and their interface with the Internet and other forms of wireless communications.

Nevertheless, cognisant of the above potential threat to their markets, the financial institutions have, over last 10 years, invested enormous amounts of capital in trying to develop and trial a variety of schemes that attempt to overcome security problems with their existing product architecture. Such attempted solutions range from new security protocols and standards like SET to smart card product offerings like Mondex. Although some of these options offer security of information, all of them to date have suffered from a variety of problems resulting in extremely low take up rates. The poor adoption rate of such bank supported products and protocols have not only been due to the lack of adoption by the transaction participants themselves, that is, the merchants and consumers, but also the financial institutions inability worldwide to agree on a cost efficient standard.

This slowness by the banking and financial system to unite on an effective strategy for EFT in the information age has, due to the vast rewards that may await those who find the right solution, resulted in a number of non-banking start-ups and even more established institutions attempting to develop their own solutions via the creation of a variety of alternative payment system products and schemes which hoped to offer a viable alternative to that of a banked backed credit or debit card.

However, and yet in some ways similar to the bank's experiences with their foray into new types of secure open system products, very few schemes have actually gone to market and for those that have, none to date have been able to achieve any substantial take up either due to the lack of access to an existing substantial electronic network—that is, the bank EFT network—or the inability to create their own substantial network and thereby reach a mass market.

Although the 1990's had witnessed a proliferation of alternative electronic payment systems all, with exception of PayPal, Millicentz and Internet Cash, have so far failed to achieve substantial adoption rates and thereby reach any form of critical mass that would make them economically sustainable in the long term.

Consequently, the bank's and credit card institutions' market share has been maintained even with the advent of the internet and other wireless networks in the 1990's. Therefore, with the exception of security related issues, there is a distinct absence and impetus for the banks to rapidly improve the functionality of their EFT products and the prices they charge.

In more recent times there have been a number of developments about the globe and particularly in Australia that indicates some pressure at a political and technical level is being brought to bear on the oligarchical hold the financial institutions have enjoyed over the electronic payment system.

Firstly, financial institutions in Australia and the USA have recently come under scrutiny, and in some cases legal action, from their respective governments over their non-competitive behaviour in both the credit and debit card space. Both actions/reports, apart from indicating the vast profit margins financial institutions have enjoyed by controlling the EFTs system, have shown both respective governments regard any monopolistic behaviour by the financial institutions as undesirable and, furthermore, that they are prepared to take action and legislate to ensure a healthy competitive environment for all players to the benefit of consumers and the community as a whole.

Secondly, the recent efforts by the banks to change customer behaviour and the very type of customer they wish to attract by encouraging customers to move to phone and internet banking has resulted in a massive perception shift in the way the community view and interact with their traditional financial institutions. This is most evident in the consumer segment and is exemplified by consumer resentment toward banks, which has instigated the recent review of The Code of Banking Practice, which was extremely critical of the banks ‘social’ performance.

Thirdly, recent rapidly emerging technologies such as the Internet and wireless application protocols (WAP) during the 90's have enabled start up players to provide services on a scale and at a cost competitive price only once possible for large wellresourced organizations. Further, the information revolution has forced businesses worldwide to radically alter their business models and their relationships with their traditional service providers—for example, financial institutions—in such a profound way that it is now necessary for companies to consider solutions and companies that they previously would not have considered. Yet ironically; due to the rapid and unpredictable pace of this innovation combined with the recent upheavals and shift in trends within the technology sector, there has resulted in larger organisations like financial institutions being increasingly reluctant to seek first mover advantages for fear they may be soon lumbered with old technologies.

There exist concerns on behalf of some organisations that while the increasing use of electronic means for the collection and transmission of sensitive financial data may give rise to efficiencies, it will also expose the organisation to a higher risk of inadvertent disclosure of that data. This is particularly the case where a third party such as a financial institution is involved. This is a concern both from the perspective of the security of the transaction and the confidentiality of the information.

In summary, the current EFT environment involves only banking products and services such as debit and credit Cards. All of these services run in what's commonly known as the EFTPOS and ATM systems. With the emergence of the Internet, banks have added additional account settlement services such as Bay, and other varieties of direct debit services. These products, which have dominated the EFT space, have done so solely because they have been the only available choice to the Retailer and Wholesaler to date. However, these products have been designed around a banking system architecture that was designed and built over 20 years ago. With the advent of the Internet these banking products are proving inefficient, expensive and cumbersome. In addition to this, governments are actively encouraging use of alternative non-bank financial products.

Although the major players in the banking system have attempted to modify these basic products for the internet they remain cumbersome. More importantly, the priority has been to adapt these products and services to the antiquated banking architecture rather than to best enhance merchant and customer convenience.

Any discussion of the prior art throughout the specification should in no way be considered as an admission that such prior art is widely known or forms part of common general knowledge in the field.

### DISCLOSURE OF THE INVENTION

It is an object of the invention to overcome or substantially ameliorate one or more of the disadvantages of the prior art or at least to provide useful alternative.

According to a first aspect of the invention there is provided a payment system for allowing a first party to pay for the supply of one or more goods that have been ordered from a second party, the system including:

a remote delivery terminal associated with a delivery vehicle of a third party that provides transport of the goods to the first party, the terminal being responsive to the first party and/or the third party for providing a confirmation signal to confirm that the one or more goods have been transported to the first party and to provide a predetermined value unit for the goods; and

a provider server of a fourth party for receiving the confirmation signal and for maintaining a first account for the first party and a second account for the second party, wherein, in response to the confirmation signal, the first account is debited by the predetermined value unit and the second account is credited.

Preferably, the system includes an order facility for allowing the first party to order the goods from the second party in a predetermined quantity and at a predetermined price. More preferably, the confirmation signal confirms the actual quantity of the goods delivered to and accepted by the first party and the value unit for the goods so delivered and accepted. That is, the system allows adjustments to an order to be made at the point of delivery.

Preferably, the second account is credited by the predetermined value unit. However, in other embodiments, the second account is credited with less than the predetermined value unit.

More preferably, the first account is credited in response to a financial payment from the first party to the fourth party. That is, the first party “recharges” the first account as required. The first account is known as a holder of stored value (HSV).

Preferably also, the server is responsive to the confirmation signal for determining the balance in the first account and, if that balance is within a predetermined range, providing an approval signal to the remote terminal. More preferably, if the balance of the first account is outside the predetermined range the server provides a halt signal to the remote terminal. That is, if the first account balance is not sufficient to allow the delivery of the goods then the third party and/or the first party are informed.

In a preferred form the predetermined range has a lower limit that is zero. However, in other embodiments the lower limit is greater than or less than zero. That is, some parties are entitled to, in effect, a credit facility.

Preferably, the first party is a retailer who on-sells the one or more goods to customers and the second party is a wholesaler. More preferably, the second party and the third party are part of the same commercial organisation.

Preferably also, the server maintains first party transaction records and the system also interacts with a first party terminal for allowing the first party to access those records. More preferably, the transaction records include data indicative of one or more of the following: the nature and quantity of the goods delivered to the first party; the date of the deliveries; time of deliveries; the predetermined value units assigned to those goods; and the debits and credits made to the first account; any adjustments made at the point of delivery.

In a preferred form, the server debits the first account in response to the first party accessing the first party transaction records.

Preferably also, the server provides the first party transaction records as web based pages and the first terminal includes a web browser for viewing the web pages. In other embodiments, the first server allows the first party to designate one of a plurality of formats for the transaction records. Some examples of these formats include:

1. HTML

2. XML

3. Spreadsheet, such as Microsoft Excel@

4. SQL format

5. Word processor, such as Microsoft Word 6. An income tax return format such as GST statements, quarterly statements, annual statements and the like

7. Graphically

8. Together with historical data

In a preferred form the transaction information is provided to the first party in an electronic form. More preferably, the server is scheduled to automatically provide the first party transaction records, in the selected format, to the first party terminal. More preferably the scheduling is triggered on the basis of one or more of the following: time; date (for example, month end); a cumulative quantum of transactions of goods; a cumulative quantum of value units; or a cumulative quantum of movements in balance of the first account.

Preferably, the server maintains second party transaction records and the system interacts with a second terminal for allowing the second party to access the second party transaction records. More preferably, the second account for the second party is debited in response to a financial payment from the fourth party to the second party. Even more preferably, the second terminal allows the second party to access the second party transaction records from the server, wherein the second party transaction records include data indicative of one or more of the following: the nature and quantity of the goods delivered to the first party; the date of the deliveries; the date and time of payment by the first party; the predetermined value units assigned to those goods; and the debits and credits made to the second account.

Preferably also, the second account is debited in response to the second party transaction records being accessed by the second party. In other embodiments the second party makes alternative payments to the fourth party, for example, a flat fee for a given time period or the like.

In a preferred form, the server is responsive to an order signal from the second terminal for providing order information to the remote terminal.

Preferably, the system includes a portable data carrier that is used by the first party for interacting with the first terminal and/or the remote delivery terminal, the portable data carrier including identification data associated with the first party that is recognised by the respective terminal. More preferably, the data carrier is selected from the group consisting of: a card having a magnetic strip; a smart card, a SIM card; a MIL key; a challenge-response security card; and a radio frequency identification card. Even more preferably, the identification data must be accompanied by a security code that is entered into the first terminal by the first party. The code, in some embodiments, originates from the fourth party's server or peripheral security system.

Preferably also, the identification data includes a unique character string for the first party.

In a preferred form, the server maintains a third account for the third party that is credited in response to a financial payment from the third party to the fourth party. More preferably, the server maintains third party transaction records and the system includes a third party terminal for allowing the third party to access the third party transaction records. Even more preferably, the fourth terminal is the remote delivery terminal.

Preferably, the first, second, third and fourth parties, have respective first, second, third and fourth bank accounts and the server interacts with those accounts at selected times to:

determine financial equivalents for any credits in the first, second and fourth accounts;

transfer the financial equivalents from the fourth bank account to the respective first, second and third accounts; and

zero balance any credits in the first, second and fourth accounts.

Preferably also, the server interacts with the accounts at selected times to:

determine financial equivalents for any debits in the first, second and third accounts;

transfer the financial equivalents from the respective first, second and third accounts to the fourth bank account; and

zero balance any debits in the first, second and fourth accounts.

According to a second aspect of the invention there is provided a method for allowing a first party to pay for the supply of one or more goods that have been ordered from a second party, the method including:

associating a remote delivery terminal with a delivery vehicle of a third party that provides transport of the goods to the first party, the terminal being responsive to the first party and/or the third party for providing a confirmation signal to confirm that the one or more goods have been transported to the first party and to provide a predetermined value unit for the goods;

receiving the confirmation signal with a provider server of a fourth party; and

maintaining a first account for the first party and a second account for the second party with the server, wherein, in response to the confirmation signal, the first account is debited by the predetermined value unit and the second account is credited.

According to a third aspect of the invention there is provided a payment system for allowing a first party to pay for the supply of one or more goods that have been ordered from a second party, the system including:

a first terminal for allowing the first party to place an order for the one or more goods, where the order has a predetermined value unit assigned to it;

a provider server of a third party for receiving the order and for maintaining a first account for the first party which, in response to the order, is debited by the predetermined value unit wherein, following the debit, the server provides a delivery signal; and

a remote delivery terminal associated with a delivery vehicle of a fourth party for receiving the delivery signal such that, in response thereto, the one or more goods are transported in the delivery vehicle from the second party to the first party.

Preferably, the account is credited in response to a financial payment from the first party to the third party. More preferably, the server provides the delivery signal only if, following the debit, the account includes a balance that is within a predetermined range. Even more preferably, the predetermined range has a lower limit that is zero. However, in other embodiments the lower limit is greater than or less than zero.

Preferably also, the first party is a retailer who on-sells the one or more goods to customers and the second party is a wholesaler. More preferably the second party and the fourth party are part of the same commercial organisation.

In a preferred form, the server maintains first party transaction records and the first terminal allows the first party to access those records. More preferably, the transaction records include data indicative of one or more of the following: the orders made by the first party; the predetermined value units assigned to those orders; and the debits and credits made to the first account.

Preferably also, the server debits the first account in response to the first party accessing the first party transaction records. More preferably, the server provides the first party transaction records as web based pages and the first terminal includes a web browser for viewing the web pages. More preferably, the server maintains second party transaction records, the system including a second terminal for allowing the second party to access the second party transaction records. Even more preferably, the server maintains a second account for the second party that is credited in response to a financial payment from the second party to the third party.

Preferably, the system includes a second terminal for allowing the second party to access the second party transaction records from the server, wherein the second party transaction records include data indicative of one or more of the following: the orders made by the first party; the predetermined value units assigned to those orders; and the debits and credits made to the second account. More preferably, the second account is debited in response to the second party transaction records being accessed.

In a preferred form, the remote delivery terminal is actuated by the fourth party to request a delivery signal from the server. More preferably, the remote delivery terminal is actuatable by the first party and/or the fourth party, upon the goods being transported to the first party, to provide a confirmation signal. Even more preferably, the server is responsive to the confirmation signal for debiting the second account and for including in the second party transaction records data indicative of the date and time of the confirmation signal.

Preferably also, the system includes a portable data carrier that is used by the first party for interacting with the first terminal and/or the remote delivery terminal, the portable data carrier including identification data associated with the first party that is downloaded to the respective terminal. More preferably, the data carrier is selected from the group consisting of: a card having a magnetic strip; a smart card, a SIM card; a MILTM key; and a radio frequency identification card. Even more preferably, the identification data includes a unique character string for the first party.

Preferably, the server maintains a fourth account for the fourth party that is credited in response to a financial payment from the fourth party to the third party. More preferably, the server maintains fourth party transaction records and the system includes a fourth terminal for allowing the fourth party to access the second party transaction records. Even more preferably, the fourth terminal is the remote delivery terminal. It is also preferred that the remote delivery terminal is actuatable by the first party and/or the fourth party, upon the goods being transported to the first party, to provide a confirmation signal.

Preferably also, the server is responsive to the confirmation signal for crediting the fourth account and for including in the second party transaction records data indicative of the date and time of the confirmation signal. More preferably, the server debits the fourth account in response to the fourth party transaction records being accessed.

In a preferred form, the first, second, third and fourth parties include respective first, second, third and fourth bank accounts and the server interacts with those accounts at selected times to:

determine financial equivalents for any credits in the first, second and fourth accounts;

transfer the financial equivalents from the third bank account to the respective first, second and fourth accounts; and

zero balance any credits in the first, second and fourth accounts.

More preferably, the server interacts with the accounts at selected times to:

determine financial equivalents for any debits in the first, second and fourth accounts;

transfer the financial equivalents to the respective first, second and fourth accounts from the third bank account; and

zero balance any debits in the first, second and fourth accounts.

Preferably, the confirmation signal provided by the remote terminal includes data indicative of the actual quantity of nature of goods delivered to the first party.

Preferably also, the remote terminal wirelessly transmits the confirmation signal. However, in other embodiments, the remote terminal is selectively docked to allow the transmission of the confirmation signal. That is, the remote terminal, between successive dockings, stores the required information.

According to a fourth aspect of the invention there is provided a method for allowing a first party to pay for the supply of one or more goods that have been ordered from a second party, the method including:

allowing the first party to place an order for the one or more goods using a first terminal, where the order has a predetermined value unit assigned to it;

receiving the order with a provider server of a third party;

maintaining with the server a first account for the first party which, in response to the order, is debited by the predetermined value unit wherein, following the debit, the server provides a delivery signal; and

associating a remote delivery terminal with a delivery vehicle of a fourth party for receiving the delivery signal such that, in response thereto, the one or more goods are transported in the delivery vehicle from the second party to the first party.

According to a fifth aspect of the invention there is provided a payment system for allowing a first party to pay for the supply of one or more goods and/or services that have been ordered from a second party, the system including:

a first terminal for allowing the first party to place an order for the one or more goods and/or services, where the order has a predetermined value unit assigned to it;

a provider server of a third party for receiving the order and for maintaining a first account for the first party and a second account for the second party wherein, in response to the order, the first account is debited by a first amount that is contingent upon the predetermined value unit and, following the debit, the server provides a delivery signal;

a second terminal for allowing the second party to receive the delivery signal such that, in response thereto, the one or more goods and/or services are supplied to the first party; and

an input terminal for allowing the first party and/or the second party to generate a confirmation signal once the goods and/or services have been supplied wherein the server is responsive to the confirmation signal for crediting the second account by a second amount that is contingent upon the predetermined value unit.

Preferably, the first party generates the confirmation signal and the first terminal is also the input terminal. More preferably, the first party generates the confirmation signal and the second terminal is also the input terminal. More preferably, the second party generates the confirmation signal and the second terminal is also the input terminal.

In a preferred form one or both of the first and the second amounts are proportional to the predetermined value unit. In other embodiment, however, one or both of the first and the second amounts include an offset from the predetermined value unit. More preferably, the offset is a predetermined percentage of the predetermined value unit.

Preferably also:

the first party includes a portable data carrier that contains identification information for the first party;

the second terminal includes the input terminal; and

the second terminal interacts with the data carrier for accessing the identification information.

In a preferred form the identification information is included in the confirmation signal. More preferably, the confirmation signal includes data indicative of the time at which that signal was generated.

According to a sixth aspect of the invention there is provided a method for allowing a first party to pay for the supply of one or more goods and/or services that have been ordered from a second party, the method including:

allowing the first party to place an order for the one or more goods and/or services using a first terminal, where the order has a predetermined value unit assigned to it;

receiving the order with a provider server of a third party;

maintaining a first account for the first party and a second account for the second party wherein, in response to the order, the first account is debited by a first amount that is contingent upon the predetermined value unit and, following the debit, the server provides a delivery signal;

allowing the second party to receive the delivery signal with a second terminal such that, in response thereto, the one or more goods and/or services are supplied to the first party; and

allowing the first party and/or the second party to generate a confirmation signal with an input terminal once the goods and/or services have been supplied, wherein the server is responsive to the confirmation signal for crediting the second account by a second amount that is contingent upon the predetermined value unit.

According to a seventh aspect of the invention there is provided a payment system for allowing a first party to be supplied with one or more goods and/or services that have been ordered from a second party, the system including:

a provider server of a third party for maintaining a first client account and a second client account for the first party and the second party respectively;

an input terminal for allowing the first party and/or the second party to generate a confirmation signal to confirm that the one or more goods and/or services have been supplied to the first party and to provide a predetermined value unit for the goods and/or services, wherein the confirmation signal is provided to the server for actuating a debiting of the first client account by a first amount that is contingent upon the predetermined value unit and a crediting of the second client account by a second amount that is contingent upon the predetermined value unit; and

an account server for interfacing between the provider server and a banking system that has a first bank account, a second bank account and a third bank account that are respectively associated with the first party, the second party and the third party, wherein the account server selectively allows at least one of:

the variation of the first client account in accordance with a corresponding financial payment between the first bank account and the third bank account; or

the variation of the second client account in accordance with a corresponding financial payment between the second account and the third account.

According to an eighth aspect of the invention there is provided a method for allowing a first party to be supplied with one or more goods and/or services that have been ordered from a second party, the system including:

maintaining a first client account and a second client account for the first party and the second party respectively with a provider server of a third party;

allowing the first party and/or the second party to generate a confirmation signal with an input terminal to confirm that the one or more goods and/or services have been supplied to the first party and to provide a predetermined value unit for the goods and/or services, wherein the confirmation signal is provided to the server for actuating a debiting of the first client account by a first amount that is contingent upon the predetermined value unit and a crediting of the second client account by a second amount that is contingent upon the predetermined value unit; and

interfacing between the provider server and a banking system with an account server, the banking system having a first bank account, a second bank account and a third bank account that are respectively associated with the first party, the second party and the third party, wherein the account server selectively allows at least one of:

the variation of the first client account in accordance with a corresponding financial payment between the first bank account and the third bank account; or

the variation of the second client account in accordance with a corresponding financial payment between the second account and the third account.

According to a ninth aspect of the invention there is provided a payment system for allowing a first party to be supplied with one or more goods and/or services that have been ordered from a second party, the system including:

a provider server of a third party for maintaining a first client account and a second client account for the first party and the second party respectively;

a first terminal for allowing the first party to place an order for the one or more goods and/or services, where the order is provided to the server and has a predetermined value unit assigned to it and the first client account is debited by a first amount that is contingent upon the predetermined value unit;

an input terminal for allowing the first party and/or the second party to generate a confirmation signal to confirm that the one or more goods and/or services have been supplied to the first party, wherein the confirmation signal is provided to the server for actuating a crediting of the second client account by a second amount that is contingent upon the predetermined value unit; and

an account server for interfacing between the provider server and a banking system that has a first bank account, a second bank account and a third bank account that are respectively associated with the first party, the second party and the third party, wherein the account server selectively allows at least one of:

the variation of the first client account in accordance with a corresponding financial payment between the first bank account and the third bank account; or

the variation of the second client account in accordance with a corresponding financial payment between the second account and the third account.

Preferably, the first amount equals the second amount. More preferably, either or both of the first amount and the second amount are a percentage of the predetermined unit value. In other embodiments, however, either or both of the first amount and the second amount differ from the predetermined unit value by a fixed amount.

According to a tenth aspect of the invention there is provided a method for allowing a first party to be supplied with one or more goods and/or services that have been ordered from a second party, the method including:

maintaining a first client account and a second client account for the first party and the second party respectively with a provider server of a third party;

allowing the first party to place an order for the one or more goods and/or services with a first terminal, where the order is provided to the server and has a predetermined value unit assigned to it and the first client account is debited by a first amount that is contingent upon the predetermined value unit;

allowing the first party and/or the second party to generate a confirmation signal with an input terminal to confirm that the one or more goods and/or services have been supplied to the first party, wherein the confirmation signal is provided to the server for actuating a crediting of the second client account by a second amount that is contingent upon the predetermined value unit; and

interfacing between the provider server and a banking system with an account server, the banking system having a first bank account, a second bank account and a third bank account that are respectively associated with the first party, the second party and the third party, wherein the account server selectively allows at least one of:

the variation of the first client account in accordance with a corresponding financial payment between the first bank account and the third bank account; or

the variation of the second client account in accordance with a corresponding financial payment between the second account and the third account.

According to an eleventh aspect of the invention there is provided a payment system for allowing a first party to be supplied with one or more goods and/or services that have been ordered from a second party, the system including:

a remote terminal of a third party being responsive to either of the first party or the third party for providing a confirmation signal that includes first data to confirm that the goods and/or services have been supplied to the first party and second data to indicate a value unit that has been assigned to the goods and/or services; and

a provider server of a fourth party for maintaining a first account and a second account for the first party and the second party respectively, the server being responsive to the confirmation signal for debiting the first account and crediting the second account.

Preferably, the debit to the first account is matched by a corresponding credit to a holding account. More preferably, the first party has a predetermined time from the credit to the holding account to make a financial payment to the fourth party. Even more preferably, the financial payment is a function of the credit.

According to a twelfth aspect of the invention there is provided a method for allowing a first party to be supplied with one or more goods and/or services that have been ordered from a second party, the method including:

providing a confirmation signal with a remote terminal of a third party, where the remote terminal is responsive to either of the first party or the third party and the confirmation signal includes first data to confirm that the goods and/or services have been supplied to the first party and second data to indicate a value unit that has been assigned to the goods and/or services; and

maintaining with provider server of a fourth party a first account and a second account for the first party and the second party respectively, the server being responsive to the confirmation signal for debiting the first account and crediting the second account.

### BRIEF DESCRIPTION OF THE DRAWINGS

A preferred embodiment of the invention will now be described, by way of example only, with reference to the accompanying drawings in which:

FIG. 1 is a block diagram that schematically represents a payment system according to the invention;

FIG. 2 is a schematic representation of the prior art EFT system;

FIG. 3 is a schematic representation of the system according to the present invention;

FIG. 4 is a schematic representation of the prior art wholesale route trade;

FIG. 5 is a schematic representation of the route trade according to an embodiment of the invention;

FIG. 6.1 is a schematic representation of the system of FIG. 1 in more detail;

FIG. 6.2 is a schematic representation similar to FIG. 6.1 that illustrates the process of “recharging” the retailer's account;

FIG. 6.3 is an index of the abbreviations used in FIGS. 6.1 and 6.2;

FIG. 7 is a schematic representation of the B2B route of the goods as they progress through the system of FIG. 1;

FIG. 8 is a schematic representation of the web site of the system of FIG. 1;

FIG. 9 is a schematic representation of a portion of the web site of FIG. 8; and

FIG. 10 is a table that illustrates the relative merits of the system of FIG. 1 in comparison to the available systems.

### DETAILED DESCRIPTION OF THE PREFERRED EMBODIMENT

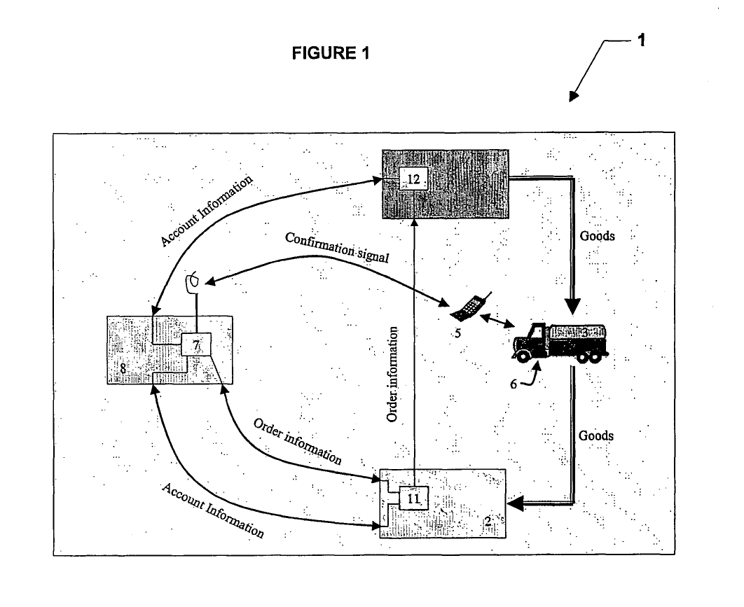

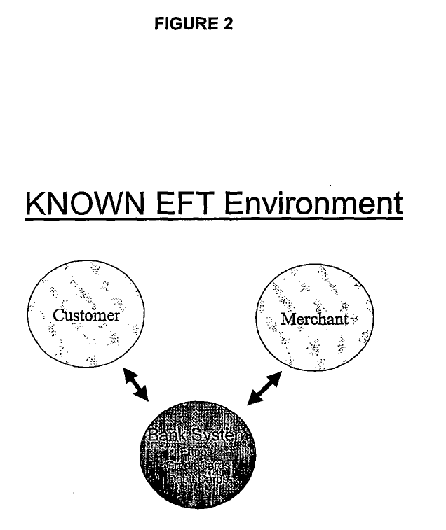

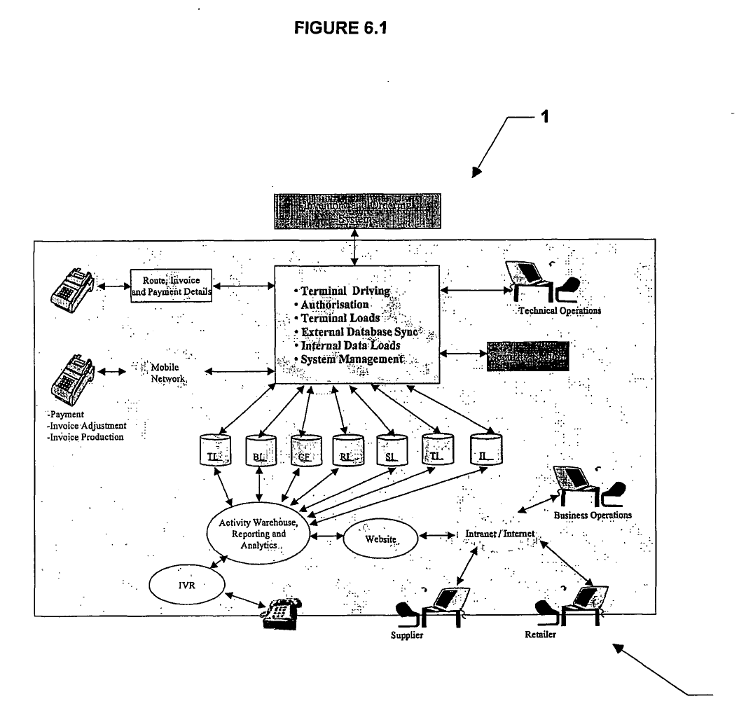

Referring to FIG. 1 and FIG. 6.1, there is shown a payment and distribution system 1 for allowing a first party, in the form of a retailer 2, to be supplied with one or more goods 3 that have been ordered from a second party in the form of a wholesaler 4. System 1 includes a remote delivery terminal 5 that is associated with a delivery vehicle 6 of a third party, where that party is a delivery agent. Vehicle 6 provides for the transport of goods 3 to the first party. Terminal 5 is responsive to the retailer 2 for providing a confirmation signal to confirm that goods 3 have been transported to the retailer and to provide a predetermined value unit for the goods. A provider server 7 is operated by a fourth party—who in this case is referred to as the provider 8—for receiving the confirmation signal and for maintaining a first account for retailer 2 and a second account for wholesaler 4, wherein, in response to the confirmation signal, the first account is debited by the and the second account is credited.

In the normal course of business, retailer 2 orders the goods from wholesaler 4 in the normal way. For example, in some cases this will be over the telephone, in others by fax or email, and others by default. The latter being the case where a standard order has been established from historical orders. In all these cases, there is the possibility that the need for the goods will have changed in the time between the placing of the order and the ultimate physical delivery of the goods to the retailer. Moreover, there are also occasionally delivery errors through the wrong allocation of goods to the delivery vehicle, the misreading of orders or damage of the goods during transit. The present embodiment, as will be understood from the teaching below, allows the retailer and/or the third party to adjust the amount invoiced to retailer 2—the predetermined value unit—to accord with the goods actually delivered, and not necessarily in strict accordance with the goods actually ordered by retailer 2. That is, this embodiment of the invention allows adjustments to the amount to be invoiced at the point of delivery. This functionality also allows wholesaler 4 to pass on any discounts or premiums that have accrued in the time between the order and the delivery.

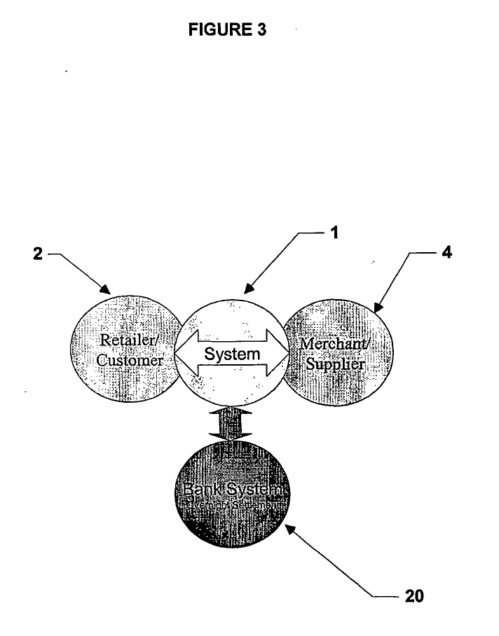

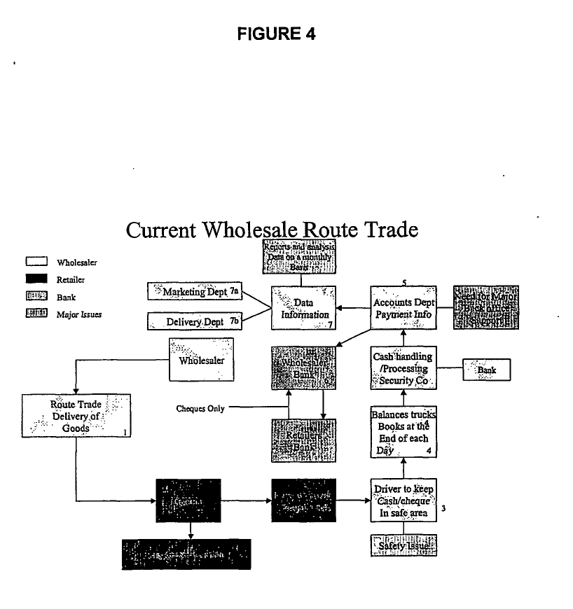

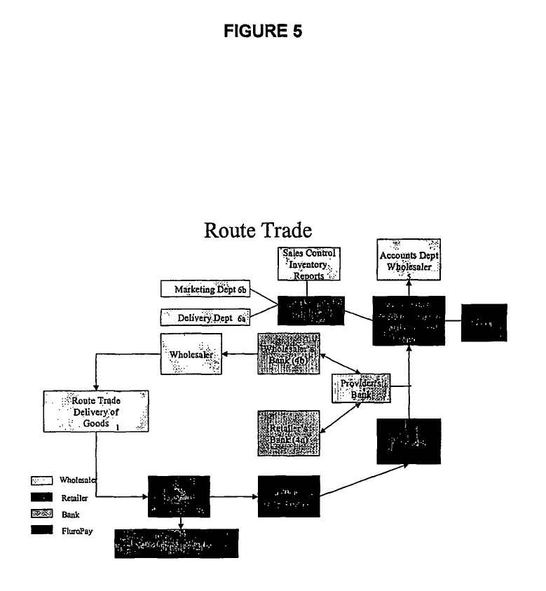

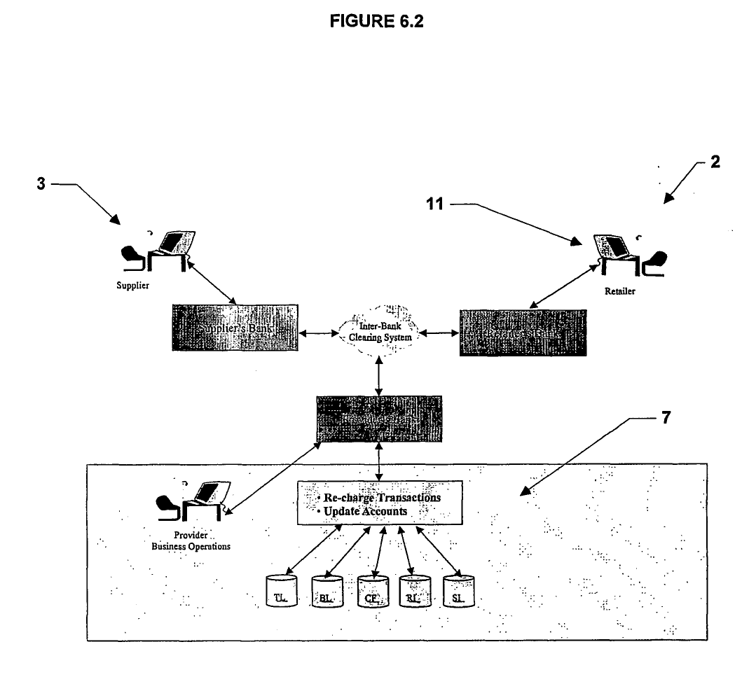

As best shown in FIG. 3, system 1, at a conceptual level, is interposed between the retailer 2, the wholesaler 4 and the banking system 20. The details of this interposing and the functionality that arises will be explored in more detail below. Moreover, the route trade that is created and facilitated by system 1 is schematically illustrated in FIG. 5. To assist the reader in the understanding of these flows, reference is also made to FIG. 7 that schematically illustrates the B2B markets for the goods as they move from the manufacturers or importers to the wholesalers, the retailers and eventually to the ultimate consumers. That is, considerable B2B transactions prior to a transaction between a business—the retailer—and the consumers. It will be appreciated that in some embodiments all of these transactions occur within the system. In this embodiment, however, it is only a subset of those transactions, that between the wholesaler and the retailer that are being focussed upon. This is for the sake of clarity and the skilled addressee will appreciate that the invention is applicable to the other transactions. It will also be appreciated that system 1 is suitable for goods and/or services that are only ever intended for B2B trade and which are not on sold to consumers. It will also be appreciated that the transactions between the retailer and the consumers, in some embodiments, takes the form of a B2C transaction.

Returning to FIG. 1 and FIG. 6.1, terminal 5 includes:

1. A housing for containing a processor;

2. A display being driven by the processor for selectively providing visual information to the third party and/or the retailer;

3. A card reader—in the form of a magnetic stripe and/or smart card reader—for facilitating the input of information into system 1;

4. An input device—in the form of a keypad and/or touch screen capability—for facilitating interaction with the terminal;

5. An energy storage device such as a battery; and

6. A printer for providing a printed record for a given transaction.

Also included is a wireless communication capability for allowing the confirmation signal to be sent to server 7 and for subsequently receiving other signals for that and server and other sources. In this embodiment the wireless communication device is a GSM compatible transceiver and is mounted within the housing. However, in other embodiments terminal 5 includes a port for allowing connection of to a GSM of other mobile telephone. In further embodiments terminal 5 is connected to the communication device only periodically and the batch transmission of a plurality of confirmation signals. For example, this could occur only once a day. Preferably, however, the connection and communication is established at the time of delivery of goods 3.

The input means of terminal 5 includes a slot or other reader for allowing data to be obtained from a card such as a card having a magnetic strip or a smart card. Both retailer 2 and the delivery agent have cards that are capable of interaction with the slot for allowing the selective exchange of data.

Upon the delivery of goods 3, the delivery agent swipes their respective card across the slot to download to terminal 5 first identification data that has been allocated to and which is unique to that agent. In other embodiments use is made of other means for the agent to effectively unlock terminal 5 and identify him or herself to the terminal. So while this embodiment makes use of a magnetic stripe card and an agent PIN, other embodiments utilise a smart card plus an agent PIN, or an agent number and password.

Once terminal 5 is unlocked and operational, the agent uses the keypad to enter the type and quantity of goods 3 or other descriptor. However, in some embodiments, that data is already contained within the memory of terminal 5, having been downloaded by the delivery agent prior to or at the time of loading the relevant goods into vehicle 6. That being, the case, all that is required is that the delivery agent and retailer 2 agree upon the order and any adjustments that have occurred or which are desired.

Once the content of the transaction has been agreed between the delivery agent and retailer the transaction is settled. That is, terminal 5 is used to produce an invoice for the goods that have actually been delivered, which includes any adjustments for changes that have occurred to since the original order was placed.

The final value unit assigned to the delivered goods, following any point of delivery adjustments, is entered into terminal 5 as a predetermined value unit for goods 3. In this embodiment, the predetermined value unit is based upon the quantity, quality and type of the goods actually delivered.

The retailer then provides selected input to terminal 5 either via the keypad or by swiping a magnetic stripe card or the like through the slot. This input includes second identification data that has been allocated to and which is unique to retailer 2. The retailer is then asked to confirm delivery of goods 3 and that the predetermined value unit is correct. This is achieved by depressing an appropriately labelled key on the keypad of terminal 5.

So, in summary,

1. The delivery agent prints the invoice at the time of delivery and provides this to the retailer.

2. The retailer advises the delivery agent whether any adjustments are required. If so, those adjustments are made by the delivery agent, by appropriate interaction with terminal 5, and a second invoice is printed with the adjustments.

3. The first invoice is either discarded or maintained as part of the agent's records.

4. After the details contained on the new invoice are checked by the retailer against the goods that have been delivered, the agent and retailer proceed to confirm the transaction.

5. Terminal 5 displays the predetermined value unit for the desired transaction, and the retailer's card is swiped through a slot in terminal 5 to enter an identifier for the retailer. In other embodiments the card is dipped, for example. The actual mechanism used being dependent upon the hardware design and whether the card is a magnetic card or smart card.

6. With the retailers identifier entered into terminal 5, the retailer then enters his or her PIN and presses the “OK” key.

7. The terminal connects to the provider's server via the mobile communications network. The data captured by terminal 5 is packaged, together with a time stamp, and transmitted as the confirmation signal.

8. The card, account, PIN, transaction amount and limits are checked by the provider's server. Note that, in this embodiment, the PIN is verified by a separate security module which resides at the provider's premises.

9. If all of these checks are passed then terminal 5 is notified by the provider's server and instructed to print a receipt confirming the successful completion of the transaction.

10. Once printed, the receipt is provided to retailer 2 to retain for his or her records.

Depending on the wholesaler's requirements, the invoice and receipt are printed on “carbon” paper—the original invoice being kept by the retailer, whereas the original receipt is kept by the agent.

It will be appreciated by the skilled addressee, that system 1 caters for exception and alarm conditions. For example, when:

1. The PIN (which the retailer entered in terminal 5) is incorrect;

2. Retailer 2 has insufficient funds in his or her account;

3. Terminal 5 is unable to receive a response from the server in time;

4. The server is down;

5. The network is down;

6. Other like contingencies occurs.

The agent then drives vehicle 6 to the location of the next retailer and delivers the goods ordered. The process of agreement upon the quantum of the goods and the predetermined value unit are repeated. It will also be appreciated that for each retailer it is possible to have a separate transaction for each of the goods or each different type of goods. However, it is preferred that the goods are sufficiently itemised both in quantity and value so that it is possible to easily distil from the information captured all the separate components of a transaction.

The agent, on the other hand, once having entered the second identification information, is able to download order information, as will be described in more detail below.

Terminal 5 is a display driven device that includes a variety of menus for allowing use by both retailer 2 and the agent. For example, retailer 2, having entered the first identification information, is able to enter and/or access details about the balance and transactions that have occurred to the first account. In some embodiments this functionality is not provided by terminal 5 and the retailer, instead, utilises the provider's website to access this information. Other embodiments use IVR/telephone access.

Downloading of order information occurs prior to the commencement of the day's route for the delivery agent. Typically, this occurs at the beginning of the current day or at the end of the previous day. Some embodiments also allow the downloading of supplementary information during the day.

Server 7 is interfaced with terminal 5 via an existing GSM mobile telecommunications network and receives the confirmation signal accordingly. Upon that receipt, the first account is debited by the predetermined value unit. That is, the retailer's account is debited in accordance with the quantum they agreed to at the time of actuating the confirmation signal. In this embodiment, and at that time, the second account is credited by the predetermined value unit. However, in other embodiments, the second account is credited with less than the predetermined value unit. That is, the provider effectively charges wholesaler 4 on a per transaction basis, the difference between the debit a n d the credit being effectively applied as a credit to a third account for the provider. It will be appreciated that the third account is also maintained by server 7. In this embodiment of the invention the invoicing for the goods occurs in real time, but the settlement is not. Fees and charges are not settled as part of the transaction but as part of a separate, typically month-end, process. This process involves calculating the transaction fees and generating the appropriate bank instructions.

The accounts represent units of value and are, in some embodiments, directly linked to the local currency. However, the link is less direct in some embodiments, such as those in which wholesaler 4 supplies goods to different retailers at different value units to promote the sale of those goods in certain geographic areas.

As retailer 2 confirms the successive delivery of goods, the first account is successively debited. The fourth party, however, through the vehicle of server 7, set limits on the available range of balances that are permissible for the first account. The onus is on the retailer to ensure that the balance remains within those limits and a failure to do so will result in a halt signal being provided to terminal 5 if a confirmation signal is received for a proposed transaction that would take the balance outside those limits. That is, the delivery agent is informed by an error message being displayed on terminal 5, that retailer 2 does not have an appropriate account balance to allow the proposed transaction to progress.

The first account is credited in response to a financial payment from the retailer to the provider. This payment occurs via prior payment means such as, for example, by way of cheque, money order or cash. However, in some embodiments, the payment is affected electronically. This process is schematically illustrated in FIG. 6.2.

Server 7 is responsive to the confirmation signal for determining the balance in the first account and, if that balance is within a predetermined range, providing an approval signal to the remote terminal. If the balance of the first account is outside the predetermined range the server provides a halt signal to terminal 5, as discussed above. In some cases, if the first account balance is not sufficient to allow the delivery of the goods then the retailer is provided with a temporary credit, although at a penalty rate.

In the present embodiment, the predetermined range has a lower limit that is zero. However, in other embodiments the lower limit is greater than or less than zero. This limit is set by the provider or the wholesaler based upon a variety of factors, such as the credit worthiness of the retailer, the history of trading and the history of payment.

While the delivery agent has been described as in independent party, it will be appreciated that, in other embodiments, that agent is part of the same commercial organisation as the wholesaler. In further embodiments the agent is part of the same commercial organisation as the provider.

Server 7 maintains first party transaction records and system 1 also includes a first party terminal 11 for allowing retailer 2 to access those records as and when required. Terminal 11 takes the form of a PC or a PDA that is accessible by the retailer and which interfaces with server 7 via the internet. To retain security of the records, server 7 is protected by security software such as a firewall and the retailer is required to input at least one user name and password to gain access the desired access. Preferably, the access also utilises encryption.

The transaction records include, amongst others, data indicative of:

1. The nature and quantity of the goods that were confirmed as being delivered to the retailer;

2. The date of the deliveries;

3. The time of the deliveries;

4. The predetermined value units assigned to the delivered goods;

5. The debits and credits made to the first account;

6. The details of any halt signals relevant to the retailer; and

7. Account preferences of the retailer, such as the format in which the statements are presented and the timing of the statements.

Server 7 provides considerable functionality and flexibility to retailer 2 in maintaining the account and in the choice of formats in which the transaction records are delivered. Accordingly, while all the above information is available, the retailer may not need all this to achieve the results they desire. In any event, the collation and presentation and, in some embodiments, the analysis of this information, is a service to the retailer and is recognised through server 7 debiting the first account in response to retailer 2 accessing the first party transaction records. In those embodiments where analysis of the information is undertaken, the quantum of the debit is increased accordingly.

Server 7, by default, provides the first party transaction records as web based pages and terminal 11 includes a web browser for viewing the web pages. However, retailer 2 is able to access server to vary that delivery format. Other options are for the records to be delivered as: 1. HTML

2. XML

3. Spreadsheet, such as Microsoft Excel@

4. SQL format

5. Word processor, such as Microsoft (V Word

6. An income tax return format

7. Graphically

8. Together with historical data

As expressed above, the transaction information is provided to retailer 2 in an electronic form. However, there are some retailers who require a hard copy of the information instead of or in addition to the electronic form.

Server 7 is scheduled to automatically provide the first party transaction records, in the selected format, to terminal 11 and, if required, to affect a mail-out of a hard copy of those records. The scheduling is triggered on the basis of one or more of the following: time; a date (for example, month end); a cumulative quantum of transactions of goods; a cumulative quantum of value units; or a cumulative quantum of movements in balance of the first account.

Server 7 also maintains second party transaction records and system 1 includes a second terminal in the form of a wholesaler server 12 for allowing wholesaler 3 to access the second party transaction records.

The second account for the wholesaler is debited in response to a financial payment from the provider to the wholesaler. That is, as successive goods are confirmed as being delivered, the second account is progressively credited. Accordingly, these points are periodically or at least systematically converted into a financial payment. In some embodiments, wholesaler 3 is also a recipient of goods from another party and the second account is debited in response to those goods being delivered to the wholesaler. In this way, each party to the system is able to function as both a buyer and seller of goods. That is, the roles are interchangeable depending upon the direction of flow of goods.

Server 12 allows wholesaler 3 to access the second party transaction records from server 7, wherein those records include data indicative of

1. The nature and quantity of the goods delivered to the first party;

2. The date of the deliveries;

3. The time of the deliveries;

4. The predetermined value units assigned to those goods;

5. The details of any halt signals;

6. The debits and credits made to the second account; and

7. Account preference of the wholesaler.

Similarly to the retailer, the wholesaler is in a position to gain considerable benefit from this collation and presentation of information. That being the case, the second account is debited in response to the second party transaction records being accessed by the wholesaler.

Server 7 is responsive to an order signal from terminal 11 for providing order information to terminal 5. That is, retailer 2 places an order for the desired goods via terminal 5. That order is accompanied by the identification information and a password for the retailer for verification purposes. Server 7 processes this information and has order information sent to terminal 5. This, in turn, allows the agent to schedule the collection of the necessary goods from wholesaler 3 and the proposed delivery of the goods to retailer 2. Preferably, the agent, in response to the order information, provides a receipt signal to server 7 that includes information indicative of the proposed time of delivery. This information is then accessible to retailer 2 via terminal 11.

System includes a portable data carrier in the form of a card (not shown) that is used by retailer 2 for interacting with terminal 5 and, if required, terminal 11. The card includes identification data associated with retailer 2 that is recognised by the respective terminal during that interaction. The data is stored in magnetic form on a strip of magnetically recordable material on one side of the card. In other embodiments, the card is selected from the group consisting of: a smart card, a SIM card; a MIL key; and a radio frequency identification card.

The identification data must be accompanied by a security code provided by the retailer, where the identification data includes a unique character string for the retailer and the security code is another character string that is known only to the retailer.

Server 7 maintains a third account for the agent that is credited in response to a financial payment from the agent to the provider. Moreover, server 7 maintains third party transaction records and system 1 includes a third party terminal, in the form of terminal 5, for allowing the agent to access the third party transaction records. The agent is also able to access the records with other means such as PC. While terminal 5 communicated with server 7 by way of a GSM protocol, a PC is usually connected to server 7 via the internet.

The retailer, the wholesaler, the delivery agent and the provider have respective first, second, third and fourth bank accounts and server 7 interacts with those accounts at selected times to:

determine financial equivalents for any credits in the first, second and fourth accounts;

transfer the financial equivalents from the fourth bank account to the respective first, second and third accounts; and zero balance any credits in the first, second and fourth accounts.

The times are selected in accordance with an understanding between the respective parties and usually occurs on a daily, a weekly or a monthly basis.

Server 7 also interacts with the accounts at selected times to:

determine financial equivalents for any debits in the first, second and third accounts;

transfer the financial equivalents from the respective first, second and third accounts to the fourth bank account; and

zero balance any debits in the first, second and fourth accounts.

Again, the times are selected in accordance with an understanding between the respective parties and usually occurs on a daily, a weekly or a monthly basis.

In some embodiments, particularly those where orders by the retailer are placed through system 1, the balancing of credits and debits occurs at the time of order rather than at the time of delivery. However, in alternative embodiments where ordering occurs through system 1, the predetermined value unit for the nominated order is placed on hold in the first account for a given time before the second account is credited. This placing of funds on hold is to safeguard the retailer from having to subsidise delays in delivery. That is, the predetermined value unit will be quarantined and still showing as part of the retailers balance until such time as the goods are actually confirmed as having been delivered. In some embodiments the proportion of the predetermined value unit that is ultimately debited from the separate account is reduced in accordance with the extent of the delay by the wholesaler and/or the agent in affecting the delivery.

It will be appreciated by the skilled addressee, from the teaching herein, that the preferred embodiments are equally applicable to the delivery of services or goods and/or services.

The preferred embodiments of the invention provide an alternate payment and transaction service that benefits both the wholesaler and the retailer alike. System 1 not only allows ease of transfer of payment for goods and/or services but also the effective tracking of inventory and tax payments. That is, part of the analysis provided by the provider is to provide the retailer and/or the wholesaler with formatted taxation or accounting documents for given period to facilitate the preparation of the necessary taxation returns and other financial reports.

System 1 offers retailers, wholesales and other merchants with a flexible and convenient tool for reducing delivery and fulfilment costs. These costs are reduced by obviating the need for much of the cash handling at the point of transaction. This, in turn, reduces both security costs and the need for back office accounting facilities.

Moreover, system 1 provides merchants with faster access to transaction data to enable far better control and planning of:

1. Inventory;

2. Marketing;

3. Route trade effectiveness;

4. Delivery systems; and

5. Margins.

This functionality is enables as system 1, through the remote terminals accessing server 7 via the internet or other communications channel, allows the retailer, the wholesaler and the agent to instantly accesses to account and transaction information that they require. Moreover, the system is automated, where required, to provide periodic reporting.

System 1 also has the flexibility to offer the information in the format required. For example, say, if the retailer must submit quarterly taxation returns, server 7 is configured to automatically generate the forms of the necessary format and to complete the form in so far as the transaction records allow. This form is then sent to the retailer either in paper for electronic form, as specified by the retailer. Similar functionality is also provided to the other parties.

A significant advantage of system 1 is that it allows both the retailer and the wholesaler to adjust delivery orders and invoicing at point of sale. That is, if the agent, upon delivering the ordered goods to the retailer determines that:

1. The goods are damaged;

2. The retailer has determined that not all of the goods will be required;

3. The retailer has determined that more of the goods will be required;

4. The goods are not those that were ordered; or

5. Other factors;

then the confirmation signal will not be provided by the retailer and the transaction will not occur.

Where a delivery does not occur the relevant reason is selected from the choices available on the menu provided by terminal 5 and transmitted to server 7 for subsequent processing and analysis. As will be appreciated by the skilled addressee from the teaching herein, this functionality will allow some quantification of:

1. The damage in transit caused by a particular agent. Invariably, some agents cause more damage than others;

2. The amount of defective goods provided by the wholesaler. That is, an indicator of the quality of the handling and processing of that wholesaler; and

3. The organisational skills of the retailer and how accurately they are ordering and holding stock.

This “quality control” information is then used to allow the relevant parties to monitor their activities and to strategically modify those activities to improve performance or to isolate areas where additional effort and/or training is required.

In summary, the system effectively:

1. Puts the retailer and the wholesaler relationship first thereby enhancing the retailers ability to deliver customer satisfaction.

2. Gives the retailer and the wholesaler complete control of not only payment but also of the transaction data and subsequent applications.

3. Helps to reduce the retailer's fulfilment overheads and thereby to provide cheaper goods to the customer.

Significantly, system 1 allows the provider considerable flexibility to quickly and easily perform a variety of value added services to the retailer, the wholesaler and the agent, as the case may be. These services can be modified and customised to suit each party's specific needs and requirements and to levy charges commensurate with the value being added. Furthermore, system 1 accommodates a variety of transactions over a variety of different networks and conditions simultaneously. For example, a TCP/IP network, the internet and a GSM network.

As described above, system 1 allows for a cashless transaction to occur between the wholesaler and the retailer. The delivery agent has the terminal, which operates over a GSM network and which interacts with the retailer's card. This allows for the transaction to occur free of cash taking away any security fears for the retailer as they don't have to keep cash to pay for goods that will be delivered that day. The security fears for the wholesaler are also alleviated as the cash taken from the deliveries and the entire takings over a day.

System 1 allows for payments—in the form of a transfer of predetermined value units—that are initiated at the point of delivery but which occur remotely. In the embodiment described above, that transfer occurs automatically once the confirmation signal is received by server 7 and it has been verified that there are sufficient funds to allow the transaction to occur. However, in other embodiments, system 1 allows for manual payments into and from the accounts at a time following the delivery of the goods. One form of such manual payment occurs over the internet and, in particular, at a website of the provider. Account holders, when paying over the internet use the card number to facilitate the interaction. The following description is intended to provide a more detailed description of the on-line payment process. More particularly, the retailer, in this example:

1. Uses standard internet browser software to access a designated website of the provider.

2. Enters in their identification number or has that number downloaded from the card.

3. Enters an earlier selected internet password.

4. This opens them up to their account.

5. Clicks on a Payment Icon.

6. Enters in Invoice number from the wholesaler.

7. Enters in the amount to be paid.

8. If there are sufficient funds then an invoice number is issued.

If the account has insufficient funds, the site will automatically bring up the transfer money page and instruct the retailer that insufficient funds are in the account and more funds are needed to be transferred across.

As referred to above, system 1 provides transaction information to the parties that utilise the system. This information is generally provided in the form of account statements. In this embodiment, system 1 allows for both the wholesaler and the retailer to personalise their statements to suit their won business needs. For some parties the statements include tax/GST information, point and time of delivery or cost per units bought. Many other alternatives are available. Moreover, system 1 offers a wide range of different presentation layouts that allow tailoring of the information for the retailer and the wholesaler. For example, the parties desire, in some case, to download the data onto their desktop/server/processor as a spreadsheet or comma-separated text file.

The statements are personalised by the party contacting the provider and having the relevant software configurations affected with server 7. In some embodiments this involves the party contacting a call centre of the provider. In other embodiments, the party requiring the modification accesses the website of the provider and selects from the choices available.

The statements give, by default, all information relating to taxes paid by the party concerned, including the GST paid.

In some embodiments the statements give a detailed analysis of the cost per unit for goods bought from the wholesaler.

System 1 allows the parties to access data over selected time periods so that that party is in a position to easily collate what they have bought, using the system, over that time period. As all this information is obtainable via the web site of the provider, it obviates the need for the individual parties to maintain separate and, in effect redundant, electronic or paper records for the transactions. Individual parties are still in a position to keep their own electronic or paper records, should they so wish.

In circumstance where, say, the retailer is taking delivery of goods from a variety of wholesalers, the statements provided to the retailer also name for each delivery the wholesaler concerned and the quantum of the predetermined value unit.

The statements will also be time stamped so the retailer and wholesaler will be able to see what date and time the goods were actually paid for.

As with most route trades, orders often change at point of delivery. System 1 allows orders to be changed but, instead of hand written changes on the invoice which can cause confusion and problems on occasions in the back office, terminal 5 allows for the delivery driver (the agent) to change the order. This change is automatically provided to the back office and will also flow through to the statements, invoices, tax forms and the like. This feature of system 1 has been described more fully above.

Terminal 5 is configured to print an invoice at the point of delivery once the transaction has been confirmed. This invoice includes any taxes payable such as goods and services tax or other value added tax, stamp duty, sales tax or other government fees and changes. That is, the invoice is provided in a form that is suitable as a tax record. Following from this, the statement will also provide this tax information.

The provider's website will allow the retailer to, amongst other things:

1. Personalise and order statements.

2. Check the balance of their account.

3. Change and choose a password.

4. Conduct account queries.

And the wholesaler to, amongst other things:

1. Track Route Trade through time stamping.

2. Track sales and account information.

3. Check GST/Tax.

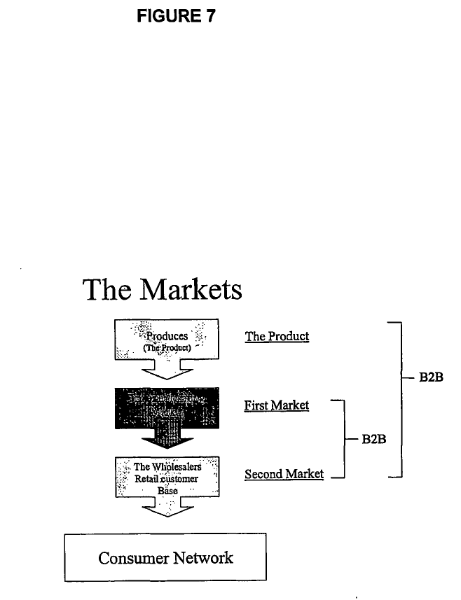

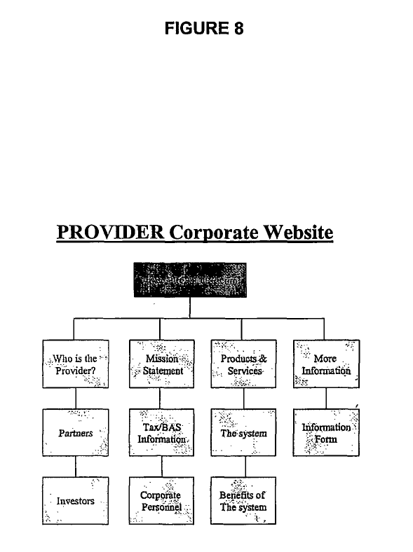

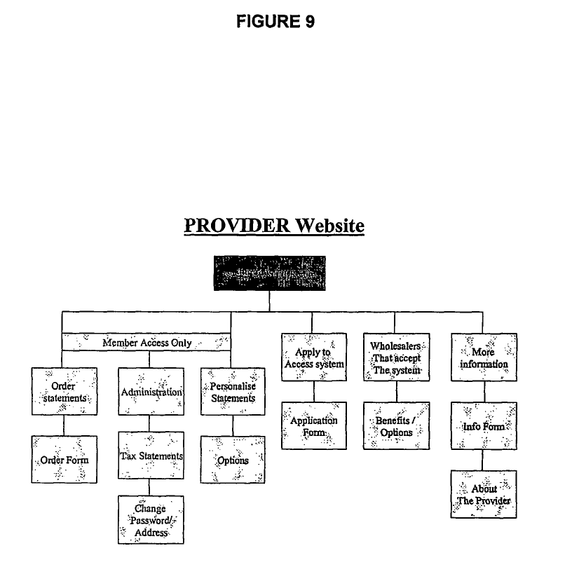

Reference is made to FIG. 8 and FIG. 9 that provide schematic representations of the web site for system 1. In other embodiments different types of web site structures are used.

The call centre function of the system will provide comfort to those parties using the system that are not entirely internet literate. With router traders it is common to encounter many retailers who operate small businesses and who do not wish to involve those businesses in unnecessary complications. At one level system 1 allows those retailers to gain efficiencies of computerisation without them having to be overly exposed to the complications that that technology can involve. That is, system 1 provides an interface for those retailers, where the interface is user friendly and simple. This theme is continued with the use of call centres to ensure that those retailers have access to human contact when discussing any difficulties that may be encountered. However, it is also envisaged that the activities of the call centres will be monitored to gauge the level of assistance that is required to be provided to any particular retailer so that education and training programs can be appropriately focussed. In some embodiments, this information is also used as a basis for calculating a debit to the account of the party concerned. This equates to a user pay system.

The call centres are also available for:

1. Enlisting new entrants into system 1.

2. Checking account balances for existing account holders

3. Ordering statements

4. Paying accounts

5. Account queries or problem solving.

The call centres have specialist operators for interacting with the wholesalers. These parties are usually more sophisticated or higher end users of the system. Typical interactions are with:

1. Account Managers.

2. Accounts Department personnel with specific queries.

3. Route delivery drivers, in the case where the drivers are part of the same organisation as the wholesaler.

The usual requests include, checking account details, ordering mobile terminals (to replace damaged terminals, for example) and account queries or problem solving.

The Retailer subscribes to system 1 via an application form presented to him by his or her supplier, which is usually the wholesaler. The retailer is presented with the option to deposit money with the provider into an account via cheque, regular direct debit, credit card, Bpay or Phone Bank. Once this occurs, and the other credit and prudential investigations are undertaken satisfactorily, the provider issues a card and PIN to the retailer.

The retailer orders the goods and/or services required in the usual manner. This same ordering process is followed by the other retailers using the system and results in the wholesaler having a database of order information. This information is sorted, filtered and otherwise collated so that relevant orders are allocated to the available delivery agents. Each agent has a terminal 5 that receives at the commencement of a delivery day a download of the orders that are relevant to that agent for that day. In some cases the agent is required to identify and load the goods into the delivery vehicle, while in other cases the warehouse personnel have also been provided with the order information and have prearranged for the relevant goods to be combined for ease of loading into the vehicle.

Preferably, the information provided to terminal 5 is given in delivery order from the first to the last delivery for that day and includes destination details, quantities ordered and order invoice details.

Once the driver—that is, the delivery agent—arrives at the destination (the retail outlet), use is made of the information on terminal 5 to confirm with the retailer that the order is correct. If it is discovered that the order is not correct the driver adjusts the order/invoice. Once the retailer and the driver have agreed upon the goods to be delivered, the driver requests payment and the retailer provides their card to the driver who swipes the card in the terminal and enters the amount of the transaction. Terminal 5 is passed to the retailer so that they may enter their Password/PIN. As discussed above, terminal 5 responds with either approval or refusal to allow the transaction.

If there are insufficient funds in the account the Driver and the retailer are informed by a text message provided in the terminal display and an audible alarm. The retailer then has the option to contact the call centre of the provider to authorise a transfer of funds from their allocated bank account or pre-notification. Alternatively, the retailer accesses the web site of the provider and arranges for a credit of their account. In this embodiment of the invention it is not intended that the funds would be transferred between accounts in real time.

Should the retailer not wish to or not be able to top up their account then they will either settle the account with cash or a cheque or by credit arrangement with the wholesaler.

When the transaction is approved, the acknowledgement by way of a time/date stamped printed receipt is issued by the terminal and given to the retailer for their records.

Once a transaction has been authorised and completed, the provider has immediately agreed to pay that transaction amount to the wholesaler. These terms and obligations will be specified within the contract between the provider and the wholesaler.

At the end of each day or another agreed period the provider instructs it's bank to settle with the wholesaler's bank the total amount owing from all transactions that have occurred that day. This single batch settlement will be the only transaction that will take place within the banking system. It will be appreciated, however, that the financial transaction is based upon a conversion of the value units that have been accumulated as a credit in relevant account maintained by server 7.

The use of the card by the retailer, by swiping in terminal 5 or otherwise, the subsequent entering of a transaction amount, and the entering of a PIN and/or password by the retailer collectively amounts to a real time request for authorisation for a transfer of funds from the retailer's account to the provider's account. This request, apart from processing the transaction similar to either a credit card or debit card transaction, activates the system into a variety of procedures that immediately format a variety of data for both parties involved in the transaction.

The type of data and in what format it is stored on server 7 is determined by the needs and requests of the parties to the system and the services that they are prepared to pay. These types of data—which have been immediately stored (in real time) and formatted as the transaction occurs—are retrievable immediately on line from the server 7 by either the provider or the wholesaler. Clearly, a wholesaler will only be provided access to that data which is relevant to the goods and/or services for which it is involved. That is, the privacy of the data for other parties is respected by way of software and, if necessary, hardware security devices.

The type of information that can be immediately retrieved is:

1. A date and time stamp for each transaction and, therefore, the delivery time.

2. The name and/or an identifier for the agent that delivered the goods.

3. The party that made the purchase and received the goods—that is, a name and/or identifier for the retailer.

4. The quantum of the transaction.

5. The quantity and type of goods purchased and delivered.

6. The per unit cost of the goods.

7. The GST component of the transaction.

Apart from the reduction in back office costs made possible by an EFT, as enabled by system 1, the ability for a wholesaler or other supplier to have instant access to both transaction and sales data has profound implications for their organisation. Some of these advantages are that it allows:

1. Daily route trade tracking.

2. Effective analysis of route trade efficiency on each route for each day of the week.

3. Instant access by all departments to sales results enabling:

3.1. More effective inventory & stock control.

3.2. More efficient stock return control.

3.3. More accurate cash flow projections.

3.4. Ability to immediately analyse marketing campaign effectiveness by examining next day market response (following next delivery).

3.5. More effective and responsive customer relationship management.

The type of data captured for the retailer, and the format in which it is stored by server 7, is determined by the retailer's needs and requests. It follows that the above information will also be available immediately on line or via the call centres referred to above. The retailers also have the option to receive regular statements via email or in the mail.

System 1 offers a flexible environment in which the provider is able to update the formats provided to all the parties, and in particular to the retailers, in response to changes in the taxation system or the banking system. This alleviates the need for each of the retailers to individually take measures to adjust their data collection and reporting tools. All of the above information can be formatted to suit the requirements of the GST in Australia, in that the format is BAS friendly, or to any other format required in other jurisdictions.

It is also important to note that copies of invoices—such as GST compliant tax invoices—are provided to replace the invoice provided by terminal 5 at the time of delivery. These subsequently generated invoices are provided typically by email or mail. The retailer or other party selects the type and mode of delivery of the invoices either via web site or a call centre request.

Some further advantages of system 1, which will be apparent to the skilled addressee from the disclosure herein, are that it allows:

1. More accurate stock and inventory control.

2. More accurate and flexible accounts management & reporting.

3. Better access to supplier services and support.

4. Automatically collated tax information.

5. Increased security due to less need for cash on premises.

6. Cheaper goods from supplier.

The charges levied by the provider to the other parties will vary depending upon the level of support provided to those parties and the level of value that is added to the operations of those parties. In other words, the pricing structure is flexibly applied to suit the nature of the business activities of the parties involved. For example, the charging regime is significantly different for large and expensive goods that require less frequent delivery and for smaller consumable goods with low margins and short turnover.

System 1 is applicable to most markets and mediums and is described with reference to the wholesale/retail trade by way of example only. It is also the case that system 1 is able to be continually changed, developed and upgraded to stay ahead and in line with the ever-changing EFT and data management industries. This inbuilt robustness provides an inherent counter to obsolescence.

System 1 allows:

1. A direct relationships between the retailer and the wholesaler.

2. A reduction of the retailer's overheads, this saving being, to some extent, passed to the customers.

3. Each party to have complete control over the transaction data relevant to them.

4. The implementation of a data management system that also acts as a payment system and a distribution system. This, in turn, allows the provider to put the wholesaler/retailer relationship first thus:

4.1. Creating a cashless transaction therefore taking away any security fears or costs associated with such fears. For example, the cost of security guards to transport large quantities of cash.

4.2. It's as quick and easy to use as cash and there is no security fears in regards to fraud as the transaction is approved or disapproved on the spot.

4.3. The statements are personally tailored, as required, to suit the individual wholesaler's or retailer's needs. This is extremely advantageous for GST collating or BAS statements.

4.4. The system has the ability to collate sales/inventory cost.

5. Changes up to and during the point of delivery. Therefore, if orders change once the route delivery vehicle is on the road, these are easily fixed upon delivery. This also has the effect of taking pressure off the back office operations of the wholesaler.

In other embodiments, system 1 allows the retailer to settle any transaction with the delivery agent with cash or a cheque. In this case, the agent interacts with terminal 5 to enter the details of the payment including the type and amount. This information is relayed to the system and reported, as requested, to the wholesaler and the retailer, along with any other required information. In still further embodiments, the retailer has the option of settling any transaction with a combination of cash and value units.

To assist the addressee the term “route trade” is used to designate any business that wholesales goods to retailers and delivers them to their door. In some cases the delivery is by way of another party, that party being referred to elsewhere in this specification as a delivery agent or driver. While system 1 is particularly well suited for application to this type of trade, it is also applicable to other forms of transactional commerce. However, of the route trades, system 1 is ideally suited to the food, drink and tobacco wholesaling industry due to the geographic coverage of these markets and quantities of goods involved. The need to effect distribution to such a geographically dislocated market and to such a diverse range of businesses and outlet creates many issues that are time consuming and labour intensive to address and resolve. Although this and similar markets are enormous in terms of turnover and are omnipresent throughout society, the number of major wholesalers is limited. This also creates logistical difficulties.

System 1 allows for goods and services to be, in effect, “paid for” using a card that is linked to a user account that is maintained remotely from the point of transaction or the point of delivery of the goods. It is an efficient and secure payment method that operates outside the existing payment system but allows an easy interface with the existing banking system.

In short, system 1 not only allows for the payment of goods and services but it also allows for the foundation of a customer relationship management (CRM) system to be used and exploited.

System 1 has a dual role, that of a system of payment, and a system for payment. That is, each party using the system have the ability to be, in some cases, in receipt of a credit to their account and, in other cases, to the receipt of a debit to their account. This debit and credit will be in response to the flow of goods and/or services within the system.

In addition to the function referred to above, wholesalers are able to accept system 1 as not only payment of goods but also to:

1. Track goods sold to retailers.

2. Give detailed account of when the goods were delivered.

3. Give detailed account of price index for goods sold.

4. Have funds in there own account by next day track exactly what the goods were exchange for.

5. Record any last minute changes to inventory system even up to and including time of delivery.

6. Track all GST and tax components of sales.

The retailer or merchant uses system 1 to not only pay for goods but also to:

1. Track goods that have been purchased using the system.

2. Track in detail the goods that were delivered.

3. Give a detailed account price index for goods purchased.

4. Track funds that have been transferred into the account maintained by server 7.

5. Record any last minute changes for the inventory system even up to and including time of delivery.

6. Track all GST and tax component of purchases.

System 1 provides an improved payment system and structure that not only facilitates transactions but also provides powerful tools that enhance and improves the wholesaler's efficiency by:

1. Enhancing customer relationship management.

2. Increase route trade efficiency.

3. Reduce route trade costs

4. Decrease back office costs

These efficiencies are possible because system 1:

1. Creates a cashless transaction

2. Relieves security fears

3. Is quick and easy to use

4. Benefits inventory/ordering

5. Is GST friendly for BAS statements

6. Tracks sales/spending

The web site of the provider includes the capability of receiving input from the parties using system 1. Specifically, input is sought that will contribute to the development of the system to gather and analyse further any information that is of perceived value to the party concerned.

Another function of the web site is to allow the retailers, wholesalers and other parties to:

1. Order and customise their statements.

2. Order and customise tax statements.

3. Apply online for subscription to the system.

4. Determine the other parties who operate within the system.

5. Determine the benefits of the system.

There will be certain restricted areas of the website that will only be able to be seen by the respective account holders. To access these restricted areas and the specific account information contained in those areas, the account holder will have to enter the following:

1. An internet account number (which is, in some embodiments, also the number of the card held by the holder of the account).

2. An internet password.

Only when these are received, verified and accepted will the account and other transactional information be able to be accessed.

It is envisaged that the website will support advertising that will be relevant to those parties using the site.

Reference is now made to FIG. 11 which is a Table illustrating the relative merits of system 1 to existing payment systems. To assist the reader some explanation of the existing system is provided below.

1. The EFTPOS system: this is a one-dimensional transfer of funds transaction that does not allow any data collection between the merchant and customer to occur.

2. The BPay system: this was brought into effect allowing for the ease of payments to be done either over the internet or via the telephone system. These mediums, in simple terms, allow for the retailers to issue accounts to their customers and allow payments via these mediums rather than in person. The BPay system gives the retailer collected data in the form of a statement that includes a registered number (customer number), date of payment and the amount paid. The customer receives a receipt number as proof of payment.

3. Cash systems: within any cash transaction no form of data collection is electronically collected. It is totally up to the merchant and customer individually to keep personal records.

4. Cheques: like cash, the system of cheques provides very little form of data collection. The wholesaler receives a cheque and once clearance has been made is left with the retailer's name and the cheque number. The retailer is only left with the cheque number and, if the cheque butt was completed, whatever information that may contain.

System 1 allows:

1. Goods and services to be paid for using an EFT network that runs completely independently of the current banking system.

2. The capture of data between the wholesaler and the retailer.

3. Both the wholesaler and the retailer to collect data in a personalised format and use it within the realms of marketing, route delivery and tax statements.

Given the above description it will be clear to the skilled addressee that system 1 provides a payment system that puts the wholesaler and the retailer first whilst at the same time providing the security expected from a transaction system. In addition to this, system 1 offers considerable and numerous advantages that cannot even be contemplated with the existing systems.

Apart from the potential of reduced cost for goods and services, system 1 provides the significant advantage of the wholesalers and retailers being able to gain instant access to their transaction details. If a comparison is made to existing systems, it is clear that a conventional bank will generally passively wait and profit from the inevitable transactions that occur within the ‘payment system’. The bank then reports separately to the relevant. System 1, however, not only enable transactions but is proactive in facilitating e-commerce by providing pertinent value added services to each part of the transaction chain.

Although the invention has been described with reference to specific examples it will be appreciated by those skilled in the art that it may be embodied in many other forms.

1. A payment system for allowing a first party to pay for the supply of one or more goods that have been ordered from a second party, the system including:
a remote delivery terminal associated with a delivery vehicle of a third party that provides transport of the goods to the first party, the terminal being responsive to the first party and/or the third party for providing a confirmation signal to confirm that the one or more goods have been transported to the first party and to provide a predetermined value unit for the goods; and
a provider server of a fourth party for receiving the confirmation signal and for maintaining a first account for the first party and a second account for the second party, wherein, in response to the confirmation signal, the first account is debited by the predetermined value unit and the second account is credited.

2. A system according to claim 1 including an order facility for allowing the first party to order the goods from the second party in a predetermined quantity and at a predetermined price.

3. A system according to claim 1 wherein the confirmation signal confirms the actual quantity of the goods delivered to and accepted by the first party and the value unit for the goods so delivered and accepted.

4. A system according to claim 1 wherein the second account is credited by the predetermined value unit.

5. A system according to claim 1 wherein the first account is credited in response to a financial payment from the first party to the fourth party.

6. A system according to claim 1 wherein the server is responsive to the confirmation signal for determining the balance in the first account and, if that balance is within a predetermined range, providing an approval signal to the remote terminal.

7. A system according to claim 1 wherein the server is responsive to the confirmation signal for determining the balance in the first account and, if the balance of the first account is outside the predetermined range, the server provides a halt signal to the remote terminal.

8. A system according to claim 7 wherein the predetermined range has a lower limit that is zero.

9. A system according to claim 1 wherein the server maintains first party transaction records and the system also interacts with a first party terminal for allowing the first party to access those records.

10. A system according to claim 9 wherein the transaction records include data indicative of one or more of the following: the nature and quantity of the goods delivered to the first party; the date of the deliveries; time of deliveries; the predetermined value units assigned to those goods; and the debits and credits made to the first account; any adjustments made at the point of delivery.

11. A system according to claim 1 wherein the server maintains second party transaction records and the system interacts with a second terminal for allowing the second party to access the second party transaction records.

12. A system according to claim 11 wherein the second terminal allows the second party to access the second party transaction records from the server, wherein the second party transaction records include data indicative of one or more of the following: the nature and quantity of the goods delivered to the first party; the date of the deliveries; the date and time of payment by the first party; the predetermined value units assigned to those goods; and the debits and credits made to the second account.

13. A system according to claim 1 wherein the server is responsive to an order signal from the second terminal for providing order information to the remote terminal.

14. A system according to claim 1 including a portable data carrier that is used by the first party for interacting with the first terminal and/or the remote delivery terminal, the portable data carrier including identification data associated with the first party that is recognised by the respective terminal.

15. A system according to claim 1 wherein the server maintains a third account for the third party that is credited in response to a financial payment from the third party to the fourth party.

16. A system according to claim 15 wherein the server maintains third party transaction records and the system includes a third party terminal for allowing the third party to access the third party transaction records.

17. A system according to claim 16 wherein the fourth terminal is the remote delivery terminal.

18. A system according to claim 1 wherein the first, second, third and fourth parties have respective first, second, third and fourth bank accounts and the server interacts with those accounts at selected times to:
determine financial equivalents for any credits in the first, second and fourth accounts;
transfer the financial equivalents from the fourth bank account to the respective first, second and third accounts; and
zero balance any credits in the first, second and fourth accounts.

19. A system according to claim 18 wherein the server interacts with the accounts at selected times to:
determine financial equivalents for any debits in the first, second and third accounts;
transfer the financial equivalents from the respective first, second and third accounts to the fourth bank account; and
zero balance any debits in the first, second and fourth accounts.

20. A method for allowing a first party to pay for the supply of one or more goods that have been ordered from a second party, the method including:
associating a remote delivery terminal with a delivery vehicle of a third party that provides transport of the goods to the first party, the terminal being responsive to the first party and/or the third party for providing a confirmation signal to confirm that the one or more goods have been transported to the first party and to provide a predetermined value unit for the goods;
receiving the confirmation signal with a provider server of a fourth party; and
maintaining a first account for the first party and a second account for the second party with the server, wherein, in response to the confirmation signal, the first account is debited by the predetermined value unit and the second account is credited.

21. A payment system for allowing a first party to pay for the supply of one or more goods that have been ordered from a second party, the system including: a first terminal for allowing the first party to place an order for the one or more goods, where the order has a predetermined value unit assigned to it; a provider server of a third party for receiving the order and for maintaining a first account for the first party which, in response to the order, is debited by the predetermined value unit wherein, following the debit, the server provides a delivery signal; and a remote delivery terminal associated with a delivery vehicle of a fourth party for receiving the delivery signal such that, in response thereto, the one or more goods are transported in the delivery vehicle from the second party to the first party.

22. A system according to claim 21 wherein the account is credited in response to a financial payment from the first party to the third party.

23. A system according to claim 21 wherein the server provides the delivery signal only if, following the debit, the account includes a balance that is within a predetermined range.

24. A system according to claim 23 wherein the predetermined range has a lower limit that is zero.

25. A system according to claim 21 wherein the server maintains first party transaction records and the first terminal allows the first party to access those records.

26. A system according to claim 25 wherein the transaction records include data indicative of one or more of the following: the orders made by the first party; the predetermined value units assigned to those orders; and the debits and credits made to the first account.

27. A system according to claim 21 wherein the server maintains second party transaction records, the system including a second terminal for allowing the second party to access the second party transaction records.

28. A system according to claim 21 wherein the server maintains a second account for the second party that is credited in response to a financial payment from the second party to the third party.

29. A system according to claim 28 wherein the system includes a second terminal for allowing the second party to access the second party transaction records from the server, wherein the second party transaction records include data indicative of one or more of the following: the orders made by the first party; the predetermined value units assigned to those orders; and the debits and credits made to the second account.

30. A system according to claim 21 wherein the remote delivery terminal is actuated by the fourth party to request a delivery signal from the server.

31. A system according to claim 30 wherein the remote delivery terminal is actuatable by the first party and/or the fourth party, upon the goods being transported to the first party, to provide a confirmation signal.

32. A system according to claim 31 wherein the server is responsive to the confirmation signal for debiting the second account and for including in the second party transaction records data indicative of the date and time of the confirmation signal.

33. A system according to claim 21 including a portable data carrier that is used by the first party for interacting with the first terminal and/or the remote delivery terminal, the portable data carrier including identification data associated with the first party that is downloaded to the respective terminal.

34. A system according to claim 21 wherein the server maintains a fourth account for the fourth party that is credited in response to a financial payment from the fourth party to the third party.

35. A system according to claim 21 wherein the server maintains fourth party transaction records and the system includes a fourth terminal for allowing the fourth party to access the second party transaction records.

36. A system according to claim 35 wherein the fourth terminal is the remote delivery terminal.

37. A system according to claim 36 wherein the remote delivery terminal is actuatable by the first party and/or the fourth party, upon the goods being transported to the first party, to provide a confirmation signal.

38. A system according to claim 37 wherein the server is responsive to the confirmation signal for crediting the fourth account and for including in the second party transaction records data indicative of the date and time of the confirmation signal.

39. A system according to claim 21 wherein the first, second, third and fourth parties include respective first, second, third and fourth bank accounts and the server interacts with those accounts at selected times to:
determine financial equivalents for any credits in the first, second and fourth accounts;
transfer the financial equivalents from the third bank account to the respective first, second and fourth accounts; and
zero balance any credits in the first, second and fourth accounts.

40. A system according to claim 39 wherein the server interacts with the accounts at selected times to:
determine financial equivalents for any debits in the first, second and fourth accounts;
transfer the financial equivalents to the respective first, second and fourth accounts from the third bank account; and
zero balance any debits in the first, second and fourth accounts.

41. A method for allowing a first party to pay for the supply of one or more goods that have been ordered from a second party, the method including:
allowing the first party to place an order for the one or more goods using a first terminal, where the order has a predetermined value unit assigned to it;
receiving the order with a provider server of a third party;
maintaining with the server a first account for the first party which, in response to the order, is debited by the predetermined value unit wherein, following the debit, the server provides a delivery signal; and
associating a remote delivery terminal with a delivery vehicle of a fourth party for receiving the delivery signal such that, in response thereto, the one or more goods are transported in the delivery vehicle from the second party to the first party.

42. A payment system for allowing a first party to pay for the supply of one or more goods and/or services that have been ordered from a second party, the system including:
a first terminal for allowing the first party to place an order for the one or more goods and/or services, where the order has a predetermined value unit assigned to it;
a provider server of a third party for receiving the order and for maintaining a first account for the first party and a second account for the second party wherein, in response to the order, the first account is debited by a first amount that is contingent upon the predetermined value unit and, following the debit, the server provides a delivery signal;
a second terminal for allowing the second party to receive the delivery signal such that, in response thereto, the one or more goods and/or services are supplied to the first party; and
an input terminal for allowing the first party and/or the second party to generate a confirmation signal once the goods and/or services have been supplied wherein the server is responsive to the confirmation signal for crediting the second account by a second amount that is contingent upon the predetermined value unit.

43. A system according to claim 42 wherein the first party generates the confirmation signal and the first terminal is also the input terminal.

44. A system according to claim 42 wherein the first party generates the confirmation signal and the second terminal is also the input terminal.

45. A system according to claim 42 wherein the second party generates the confirmation signal and the second terminal is also the input terminal.

46. A system according to claim 42 wherein:
the first party includes a portable data carrier that contains identification information for the first party;
the second terminal includes the input terminal; and
the second terminal interacts with the data carrier for accessing the identification information.

47. A system according to claim 46 wherein the identification information is included in the confirmation signal.

48. A method for allowing a first party to pay for the supply of one or more goods and/or services that have been ordered from a second party, the method including:
allowing the first party to place an order for the one or more goods and/or services using a first terminal, where the order has a predetermined value unit assigned to it;
receiving the order with a provider server of a third party;
maintaining a first account for the first party and a second account for the second party wherein, in response to the order, the first account is debited by a first amount that is contingent upon the predetermined value unit and, following the debit, the server provides a delivery signal;
allowing the second party to receive the delivery signal with a second terminal such that, in response thereto, the one or more goods and/or services are supplied to the first party; and
allowing the first party and/or the second party to generate a confirmation signal with an input terminal once the goods and/or services have been supplied, wherein the server is responsive to the confirmation signal for crediting the second account by a second amount that is contingent upon the predetermined value unit.

49. A payment system for allowing a first party to be supplied with one or more goods and/or services that have been ordered from a second party, the system including:
a provider server of a third party for maintaining a first client account and a second client account for the first party and the second party respectively;
an input terminal for allowing the first party and/or the second party to generate a confirmation signal to confirm that the one or more goods and/or services have been supplied to the first party and to provide a predetermined value unit for the goods and/or services, wherein the confirmation signal is provided to the server for actuating a debiting of the first client account by a first amount that is contingent upon the predetermined value unit and a crediting of the second client account by a second amount that is contingent upon the predetermined value unit; and
an account server for interfacing between the provider server and a banking system that has a first bank account, a second bank account and a third bank account that are respectively associated with the first party, the second party and the third party, wherein the account server selectively allows at least one of:
the variation of the first client account in accordance with a corresponding financial payment between the first bank account and the third bank account; or
the variation of the second client account in accordance with a corresponding financial payment between the second account and the third account.

50. A method for allowing a first party to be supplied with one or more goods and/or services that have been ordered from a second party, the system including:
maintaining a first client account and a second client account for the first party and the second party respectively with a provider server of a third party;
allowing the first party and/or the second party to generate a confirmation signal with an input terminal to confirm that the one or more goods and/or services have been supplied to the first party and to provide a predetermined value unit for the goods and/or services, wherein the confirmation signal is provided to the server for actuating a debiting of the first client account by a first amount that is contingent upon the predetermined value unit and a crediting of the second client account by a second amount that is contingent upon the predetermined value unit; and
interfacing between the provider server and a banking system with an account server, the banking system having a first bank account, a second bank account and a third bank account that are respectively associated with the first party, the second party and the third party, wherein the account server selectively allows at least one of:
the variation of the first client account in accordance with a corresponding financial payment between the first bank account and the third bank account; or
the variation of the second client account in accordance with a corresponding financial payment between the second account and the third account.

51. A payment system for allowing a first party to be supplied with one or more goods and/or services that have been ordered from a second party, the system including:
a provider server of a third party for maintaining a first client account and a second client account for the first party and the second party respectively;
a first terminal for allowing the first party to place an order for the one or more goods and/or services, where the order is provided to the server and has a predetermined value unit assigned to it and the first client account is debited by a first amount that is contingent upon the predetermined value unit;
an input terminal for allowing the first party and/or the second party to generate a confirmation signal to confirm that the one or more goods and/or services have been supplied to the first party, wherein the confirmation signal is provided to the server for actuating a crediting of the second client account by a second amount that is contingent upon the predetermined value unit; and
an account server for interfacing between the provider server and a banking system that has a first bank account, a second bank account and a third bank account that are respectively associated with the first party, the second party and the third party, wherein the account server selectively allows at least one of
the variation of the first client account in accordance with a corresponding financial payment between the first bank account and the third bank account; or
the variation of the second client account in accordance with a corresponding financial payment between the second account and the third account.

52. A system according to claim 51 wherein the first amount equals the second amount.

53. A system according to claim 51 wherein either or both of the first amount and the second amount are a percentage of the predetermined unit value.

54. A system according to claim 51 wherein either or both of the first amount and the second amount differ from the predetermined unit value by a fixed amount.

55. A method for allowing a first party to be supplied with one or more goods and/or services that have been ordered from a second party, the method including:
maintaining a first client account and a second client account for the first party and the second party respectively with a provider server of a third party;
allowing the first party to place an order for the one or more goods and/or services with a first terminal, where the order is provided to the server and has a predetermined value unit assigned to it and the first client account is debited by a first amount that is contingent upon the predetermined value unit;
allowing the first party and/or the second party to generate a confirmation signal with an input terminal to confirm that the one or more goods and/or services have been supplied to the first party, wherein the confirmation signal is provided to the server for actuating a crediting of the second client account by a second amount that is contingent upon the predetermined value unit; and
interfacing between the provider server and a banking system with an account server, the banking system having a first bank account, a second bank account and a third bank account that are respectively associated with the first party, the second party and the third party, wherein the account server selectively allows at least one of:
the variation of the first client account in accordance with a corresponding financial payment between the first bank account and the third bank account; or
the variation of the second client account in accordance with a corresponding financial payment between the second account and the third account.

56. A payment system for allowing a first party to be supplied with one or more goods and/or services that have been ordered from a second party, the system including:
a remote terminal of a third party being responsive to either of the first party or the third party for providing a confirmation signal that includes first data to confirm that the goods and/or services have been supplied to the first party and second data to indicate a value unit that has been assigned to the goods and/or services; and
a provider server of a fourth party for maintaining a first account and a second account for the first party and the second party respectively, the server being responsive to the confirmation signal for debiting the first account and crediting the second account.

57. A system according to claim 56 wherein the debit to the first account is matched by a corresponding credit to a holding account.

58. A system according to claim 57 wherein the first party has a predetermined time from the credit to the holding account to make a financial payment to the fourth party.

59. A method for allowing a first party to be supplied with one or more goods and/or services that have been ordered from a second party, the method including:
providing a confirmation signal with a remote terminal of a third party, where the remote terminal is responsive to either of the first party or the third party and the confirmation signal includes first data to confirm that the goods and/or services have been supplied to the first party and second data to indicate a value unit that has been assigned to the goods and/or services; and
maintaining with provider server of a fourth party a first account and a second account for the first party and the second party respectively, the server being responsive to the confirmation signal for debiting the first account and crediting the second account.
